(19) United States
(12) Patent Application Publication
(10) Pub. No.: US 2009/0130644 A1
(43) Pub. Date: May 21, 2009

(54) Test Question Constructing Method And Apparatus, Test Sheet Fabricated Using The Method, And Computer-Readable Recording Medium Storing Test Question Constructing Program For Executing The Method

(76) Inventor: Jong Min Lee, Seoul (KR)

Correspondence Address: DICKSTEIN SHAPIRO LLP, 1825 EYE STREET NW, Washington, DC, 20006-5403, US

(21) Appl. No.: 11/921,230

(22) PCT Filed: Apr. 14, 2006
(86) PCT No.: PCT/KR2006/001380

§ 371 Date: Nov. 29, 2007

(30) Foreign Application Priority Data
Jun. 16, 2005 (KR) 10-2005-0051791

(51) Int. Cl. G09B 7/00

(52) U.S. Cl. 434/327

(57) ABSTRACT

The present invention relates to a test question constructing method and apparatus, a test sheet fabricated using the method, and a computer-readable medium storing a test question constructing program for executing the method. In a case where multiple testees simultaneously take a test, correct answer arrangements are made different by the testees through mixing of choices. Further, the correct answer arrangement is adjusted such that correct answers may be not poorly distributed to a specific choice. In particular, the correct answer arrangements of adjacent testees are adjusted to be different from one another. Therefore, cheating, for example, one testee shows other testees the answers or sneaks a look at an answer sheets of other testees, can be prevented. According to the present invention, an ability to classify the testees which was a blind point of a multiple-choice objective test can be markedly improved.

### TECHNICAL FIELD

The present invention relates to a test question constructing method and apparatus, a test sheet fabricated using the method, and a computer-readable medium storing a test question constructing program for executing the method. In particular, the present invention relates to a test question constructing method and apparatus which can prevent cheating among many testees, to a test sheet fabricated using the method, and to a computer-readable medium storing a test question constructing program for executing the method.

### BACKGROUND ART

In general, tests are classified into multiple-choice objective tests which present questions and multiple choices by questions to testees and allow the testees to select one of the multiple choices, short-answer type subjective tests which present questions and allow the testees to answer in short to the questions, and essay type subjective tests which cause the testees to write answers to presented questions in an essay type.

In the essay type subjective tests, while the features and the level of knowledge of a testee can be accurately assessed, it may take considerable time for an examiner to read and understand the answers of the testee. Further, during scoring, different scores may be given for the same answer according to a subjective opinion of the examiner.

In the short-answer type subjective tests, unlike the essay type subjective tests, there is little influence of a subjective opinion of an examiner. Further, if the testee does not know a correct answer, the testee cannot answer to a question, and thus it may be impossible for the testee to luckily answer correctly as long as he/she does not know the correct answer. However, the examiner needs to directly assess whether or not the correct answer applies to each question, and thus it takes considerable time for the examiner to score.

In the multiple-choice objective tests, unlike the essay type subjective tests and the short-answer type subjective tests, a testee reads the questions and selects one choice among various numbered choices (to be selected by the testee) which are presented together with the questions. In this case, if the testee selects a number corresponding to a choice, which he considers as the correct answer of each question, into an OMR (Optical Mark Reader) card or the like, the examiner can assess and score the selection result using a computer. Therefore, an amount of time required for scoring is short, and thus the testee can immediately receive the result after the test.

At present, among various types of test systems, the multiple-choice objective tests are widely used because many people can simultaneously take a test and scoring can be easily performed.

### DISCLOSURE OF INVENTION

### Technical Problem

In recent years, with the development and spread of wireless communication techniques, up-to-date cheating among the testees using wireless communication mediums such as cellular phones has occurred, which becomes a social issue.

In particular, in the multiple-choice objective tests, because cheating is only possible if the testee knows a correct answer number, various types of cheating such as sneaking a look at an answer sheet of an adjacent testee or transmitting the answer numbers using the wireless communication mediums may easily occur, but catching of cheating may be not easily performed. Accordingly, an ability to classify the testees may be degraded, and many innocent testees may lose out.

The present invention has been finalized in order to solve the above-described problems, and it is an object of the present invention to provide a test question constructing method and apparatus, which diversifying patterns of test questions in order to prevent cheating among multiple testees, thereby improving an ability to classify the testees, a test sheet fabricated using the method, and a computer-readable medium storing a test question constructing program for executing the method.

### Technical Solution

According to an aspect of the present invention, a test question constructing apparatus includes a receiving unit which receives multiple questions meta information having attributes of the individual questions through a network, a first converting unit which converts the individual questions input through the receiving unit into data files having contents and typesetting information, a database which stores the multiple data files and meta information of the individual questions passing through the receiving unit, a correct answer arrangement generating unit including a test sheet information reading section which reads out multiple test sheet information for constructing a test sheet from the database, a choice-by question arrangement extracting section which mixes choices of each question on the basis of the read multiple test sheet information and extracts choice arrangements having a degree of mixing more than a prescribed degree of mixing, a correct answer arrangement deciding section which randomly selects one choice arrangement among the extracted choice arrangements for each test question by testees, and decides a correct answer from the selected choice arrangement as a correct answer of the corresponding test question, and a first correct answer arrangement adjusting section which checks whether or not the correct answers in a correct answer arrangement decided for each testee are poorly distributed and, when the correct answers are poorly distributed, performs a distribution processing, and a second converting unit which generates and outputs test question files having different correct answer arrangements by the testees on the basis of final correct answer arrangement information from the correct answer arrangement generating unit.

According to another aspect of the present invention, a test question constructing method includes a first process of causing a receiving unit to receive multiple questions and meta information having attributes of the individual questions through a network, a second process of causing a first converting unit to convert the individual questions input through the receiving unit into data files having contents and typesetting information and causing a database to store the data files, a third process of causing a correct answer arrangement generating unit to read multiple test sheet information from the database so as to construct questions and choices by questions of a test subject, to adjust a choice arrangement of each question by testees according to a prescribed degree of mixing so as to generate different correct answer arrangements by the testees, and to perform a distribution processing depending on whether or not the correct answers in each of the generated correct answer arrangements by the testees are poorly distributed, and a fourth process of causing a second converting unit to generate and output test question files having different correct answer arrangements by the testees on the basis of final correct answer arrangement information obtained in the third process.

### ADVANTAGEOUS EFFECTS

According to the present invention, in a case where multiple testees simultaneously take a test, correct answer arrangements are made different by the testees through choice mixing. Further, the correct answer arrangement is adjusted such that correct answers are not poorly distributed to specific choices. In particular, the correct answer arrangements of adjacent testees are adjusted to be different from one another. Therefore, cheating, for example, one testee shows other testees the answers or sneaks a look at the answers to be entered by other testees, can be prevented. According to the present invention, the ability to classify the testees, which was a blind point of a multiple-choice objective test, can be markedly improved.

### BRIEF DESCRIPTION OF THE DRAWINGS

FIG. 1 is a diagram showing the configuration of a test question constructing apparatus according to an embodiment of the present invention;

FIG. 2 is a diagram showing an example of a screen for questions and meta information input through a receiving section of FIG. 1;

FIG. 3 is a diagram showing a source sample after conversion in an XML converting section of FIG. 1;

FIG. 4 is a diagram showing an example of original correct answer-to-OMR correct answer arrangement information stored in a database of FIG. 1;

FIG. 5 is a diagram showing another example of original correct answer-to OMR correct answer arrangement information stored in a database of FIG. 1

FIG. 6 is a block diagram showing the internal configuration of a correct answer arrangement generating section of FIG. 1;

FIG. 7 is a diagram illustrating a degree of mixing to be used in a correct answer arrangement generating section of FIG. 6;

FIG. 8 is a flow chart illustrating the operation in a first correct answer arrangement adjusting section of FIG. 6;

FIG. 9 is a flow chart illustrating the operation in a second correct answer arrangement adjusting section of FIG. 6;

FIG. 10 is a diagram showing a type of an initial master test sheet to be generated in a DOC converting section of FIG. 1;

FIG. 11 is a diagram showing a case where an initial master test sheet of FIG. 10 is edited;

FIGS. 12 and 13 are diagrams individually showing cases where choices of each of the questions in the edited master test sheet of FIG. 11 are mixed differently from each other;

FIGS. 14 and 17 are diagrams illustrating the operation in an HTML converting section of FIG. 1;

FIG. 18 is a flow chart illustrating a test question constructing method according to an embodiment of the present invention;

FIG. 19 is a flow chart illustrating a correct answer arrangement generating and storing process of FIG. 18 in detail;

FIG. 20 is a flow chart illustrating a test question constructing process according to a correct answer arrangement of FIG. 18 in detail;

FIG. 21 is a diagram showing an example of an OMR card which is used in an embodiment of the present invention.

### BEST MODE FOR CARRYING OUT THE INVENTION

Hereinafter, a test question constructing apparatus and method according to an embodiment of the present invention will be described with reference to the accompanying drawings.

A test question constructing apparatus according to an embodiment of the present invention constructs test questions on an online and transmits the constructed test questions to testees online or offline.

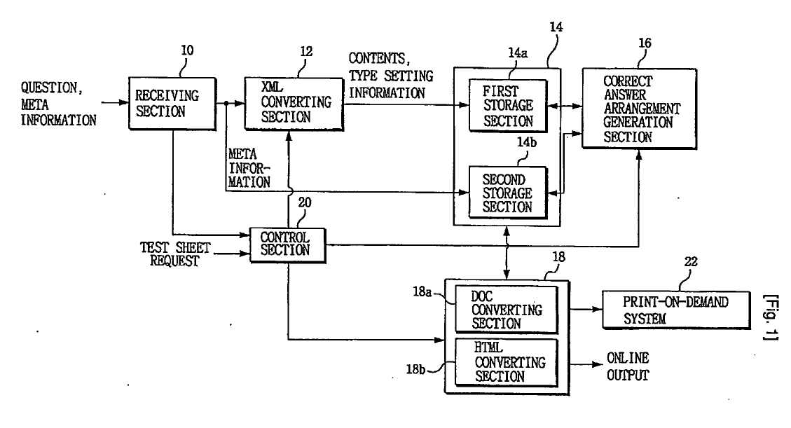

FIG. 1 is a diagram showing the configuration of a test question constructing apparatus according to the embodiment of the present invention. The configuration shown in FIG. 1 is provided within an operator server including a web server (not shown) and an exclusive-use line (not shown) (that is, a server which can receive various questions and construct the test questions in the embodiment of the present invention on the basis of the received questions).

The test question constructing apparatus of FIG. 1 includes a receiving section 10 which receives multiple questions to be provided from a personal computer of an examiner or the like (for example, questions to be created by the examiner using a general-use word processor program) and meta information including the attributes of the individual questions through a network (for example, Internet) (not shown), and an XML converting section 12 which serves as a first converting section for converting the received questions into data files (XML files) including contents and typesetting information, and a database 14 which stores the meta information of the individual questions received through the receiving section 10 and the data files by test subjects.

The test question constructing apparatus according to the embodiment of the present invention includes a correct answer arrangement generating section 16 which reads out multiple test sheet information (for example, data files and meta information) from the database 14 so as to construct the number of questions and choices of a certain test subject, adjusts choice arrangements of the questions by testees according to a pre-determined degree of mixing so as to generate different correct answer arrangements by the testees, and performs a distribution processing depending on whether or not the correct answers in the generated correct answer arrangement of each testee are poorly distributed and then separately processes the correct answer arrangements through comparison among the correct answer arrangements of adjacent testees, a second converting section 18 which generates and outputs test question files having different correct answer arrangements by the testees on the basis of correct answer arrangement information of the correct answer arrangement generating section 16, and a control section 20 which controls the operations of the individual sections.

The test question constructing apparatus according to the embodiment of the present invention also includes a data input unit such as a keyboard, a pen mouse, or a typical voice recognition software package, a display unit such as a video monitor, a voice output unit such as a speaker, and a processing unit such as a CPU. In addition, the test question constructing apparatus includes a terminal of an examiner (not shown) (for example, a personal computer (PC) or the like) which incorporates a web browser program, and software or hardware for providing wiretwireless Internet communication functions therein.

Here, in the terminal of the examiner, a general-use word processor program (for example, “WORD” of Microsoft Corporation) (hereinafter, simply referred to as “word processor”) is incorporated. Further, a program which can enable the input of the questions and meta information related to the test question construction is incorporated in the terminal of the examiner.

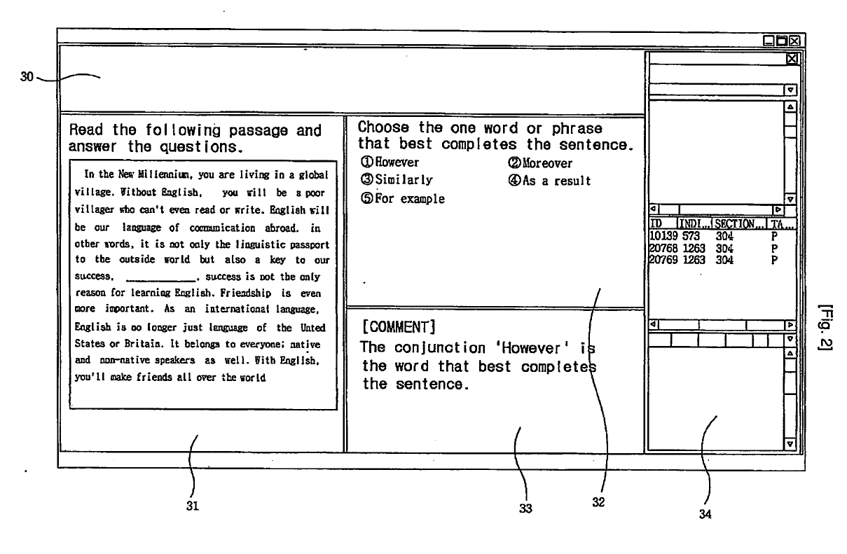

On a monitor of the terminal of the examiner, as shown in FIG. 2, a screen which is divided into a preparation portion 30 which enables the general preparation of each of the questions, a passage portion 31, a question input portion 32, a comment portion 33, and a meta information input portion 34 is displayed.

When the examiner wants to input the question, the examiner only inputs the appropriate contents into the individual divided portions. The meta information to be input into the meta information input portion 34 is dependent on the question input into the question input portion 32. The meta information includes the answer and mark of the question, the possibility of choice mixing for the question, a subject to which the question belongs, a question ID, and so on.

If the examiner inputs the appropriate contents into the individual divided portions of the screen shown in FIG. 2, the test question is provided to the testees online or offline. Further, the confirmation of a correct answer, comments, and references related to the test are provided to the testees on an online.

If the examiner inputs and stores a desired question, the meta information thereof, and so on, the question and meta information are transmitted from the terminal of the examiner to the receiving section 10 through the network such as Internet, and are converted into an XML (eXtensible Markup Language) file by the XML converting section 12. As a result of the conversion, the XML converting section 12 generates a data file called, for example, “sample.xml”.

For reference, the file called “sample.xml” is stored in a unicode encoding system (for example, UTF-8: UCS Transformation Format, 8-bit form), and then the original document can be confirmed through the word processor.

The contents input into the preparation portion 30, the passage portion 31, the question input portion 32, the comment portion 33, and so on are converted into an XML file by the XML converting section 12 and the converted XML file is stored in a first storage section 14a. The information stored in the first storage section 14a can be freely typeset by XSL and other conversion techniques.

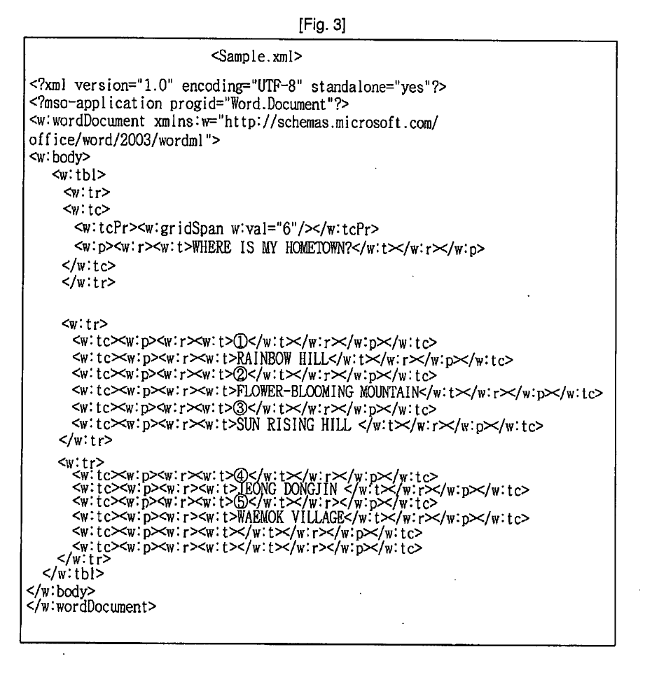

For reference, FIG. 3 shows the content of the data file (sample.xml) output from the XML converting section 12.

The contents and typesetting information are included in the data file. For example, in FIG. 3, the contents include “Where is my hometown?”, “\textcircled{1}”, “Rainbow Hill”, “\textcircled{2}”, “Flower-Blooming Mountain”, “\textcircled{3}”, “Sun rising Hill”, “\textcircled{4}”, “Jeong Dongjin”, “\textcircled{5}”, “Waemok Village”. For example, in FIG. 3, the typesetting information is information for typesetting the contents, and means information (for example, spacing words, a sequence of choices, and so on), excluding the contents.

The database 14 includes a first storage section 14a which stores the contents and the typesetting information in the data file (XML) converted by and output from the XML converting section 12, and a second storage section 14b which stores the meta information (for example, a subject, an answer, a question ID, a degree of difficulty, the possibility of choice mixing, and so on) dependent on each of the questions received through the receiving section 10. The second storage section 14b also stores correct answer arrangement information which is to be described below.

The second storage section 14b of the database 14 stores information in a form of a look-up table. In an initial look-up table, multiple question IDs (IDentification) and original correct answers by the question IDs in a state where choice mixing is not performed are stored.

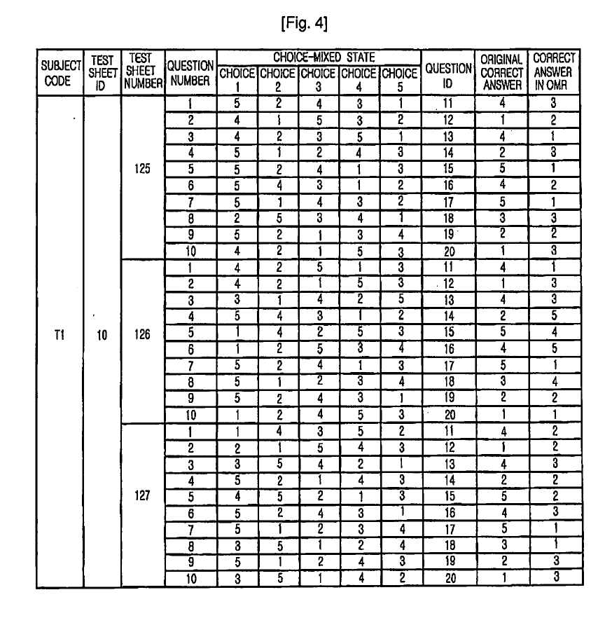

Subsequently, if the correct answer arrangement generating section 16 generates a correct answer arrangement of a predetermined number of questions for a subject in a state where choice mixing is performed and stores the generated correct answer arrangement in the second storage section 14b, the look-up table of the second storage section 14b has information for a subject code, a test sheet ID of the subject code, test sheet numbers of testees belonging to the test sheet ID, IDs of the questions in which different types of choice mixing by the test sheet numbers are performed, original correct answers of the individual questions (that is, answers before choice mixing), and OMR answers (that is, a result of choice mixing of the original answers), as shown in FIG. 4.

FIG. 4 shows that ten questions are described in the test sheets having the test sheet numbers “125”, “126”, and “127” belonging to the test sheet ID “10” for the subject code “T1”, but the correct answer arrangements of the questions by the test sheet numbers are different.

In FIG. 4, sequences of the questions corresponding to the individual test sheet numbers are the same, and only the choices of each question are mixed. Alternatively, the sequences of the questions corresponding to the individual test sheet numbers may be changed differently.

For reference, in FIG. 4, the test sheet numbers are three, which means the number of testees who take a test with the test sheet ID “10” for the subject code “T1” is three.

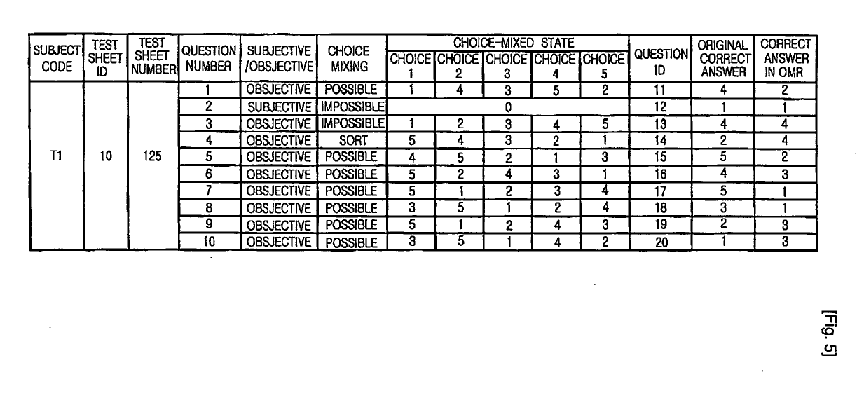

Meanwhile, option information for choice mixing can be added to the look-up table of the second storage section 14b. That is, as shown in FIG. 5, a subjective or objective type can be defined for each question, and choice mixing possible/impossible/sort can be defined.

Here, “choice mixing possible” is an option for randomly selecting one choice arrangement among choice-mixed choice arrangements with a degree of mixing of 3 or more in a random extraction manner, and “choice mixing impossible” is an option for deciding an original choice arrangement. Further, “choice mixing sort” is an option for randomly selecting one between the original choice arrangement and a choice arrangement which is arranged opposite to the original choice arrangement.

In order to construct the look-up table of the second storage section 14b in such a manner, the correct answer arrangement generation section 16 plays an important role.

When receiving a command to generate a correct answer arrangement for test sheet construction from the control section 20, the correct answer arrangement generating section 16 performs the corresponding operation. The control section 20 transmits information such as the test subject (or a subject including a test cover), the number of questions, and the number of testees to the correct answer arrangement generating section 16, together with the correct answer arrangement generation command. In addition, the control section 20 can also provide information for the number of testees by lines.

An operator who operates the apparatus according to the embodiment of the present invention can select required test questions per subject and the number of questions any time. For example, the test questions and the number of questions for a subject or within the test cover of the subject can be defined in advance, and then an original correct answer arrangement for the prescribed test questions (that is, an original correct answer arrangement in FIGS. 4 and 5) can be set in advance.

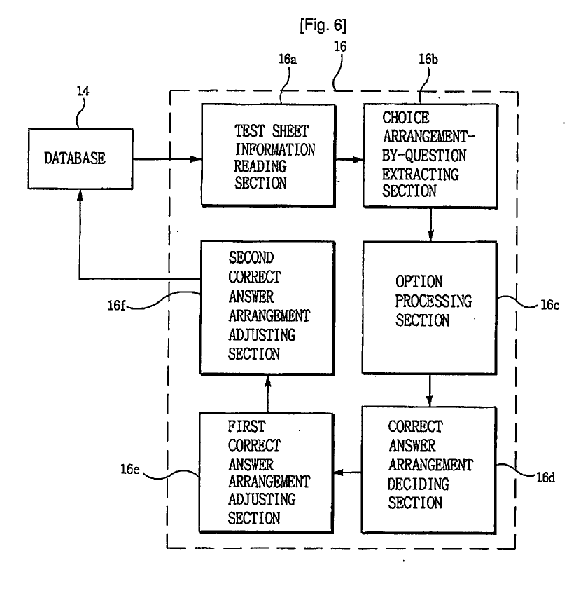

More specifically, as shown in FIG. 6, the correct answer arrangement generating section 16 includes a test sheet information reading section 16a which reads out multiple test sheet information for constructing the test sheet (for example, numbers of the test questions (question numbers), answers corresponding to the individual question numbers, scores, an option for choice mixing by the question numbers, and so on) using the meta information stored in the second storage section 14b of the database 14, and a choice arrangement-by-question extracting section 16b which mixes choices of each question on the basis of the multiple test sheet information read out by the test sheet information reading section 16a within possible limits and extracts choice arrangements having a degree of mixing more than a prescribed degree of mixing for each test question.

The correct answer arrangement generating section 16 includes an option processing section 16c which processes a choice mixing option (that is, one of choice mixing possible/impossible/sort) on the basis of option information for choice mixing of the second storage section 14b relative to the choice arrangements by the questions extracted by the choice arrangement-by-question extracting section 16b, and a correct answer arrangement deciding section 16d which randomly selects one choice arrangement for each question among the multiple choice arrangements output from the option processing section 16c, decides a correct answer of the selected choice arrangement (which is different from the original correct answer before choice mixing) as a correct answer of the corresponding question, and repeats the decision of the correct answer for each testee so as to decide different correct answer arrangements by the testees.

Further, the correct answer arrangement generating section 16 includes a fiat correct answer arrangement adjusting section 16e which checks whether or not the correct answers in the answer arrangement for each testee decided by the correct answer arrangement deciding section 16d are poorly distributed and performs a distribution processing when the correct answers are poorly distributed, and a second correct answer arrangement adjusting section 16f which, on the basis of the answer arrangements by the testees adjusted by the first correct answer arrangement adjusting section 16e, performs an adjustment such that the degree of correlation between the correct answer arrangements of adjacent testees is low.

The degree of mixing to be used in the choice arrangement-by-question extracting section 16b is preferably, set to be three or more. For example, when the choice arrangement of the original question is A, B, C, D, and E, and the choice arrangement of the original question is changed to A, C, B, D, and E, the degree of mixing becomes two.

Therefore, the degree of mixing of three or more means that the arrangement of three or more choices in the choice arrangement of the original question is changed.

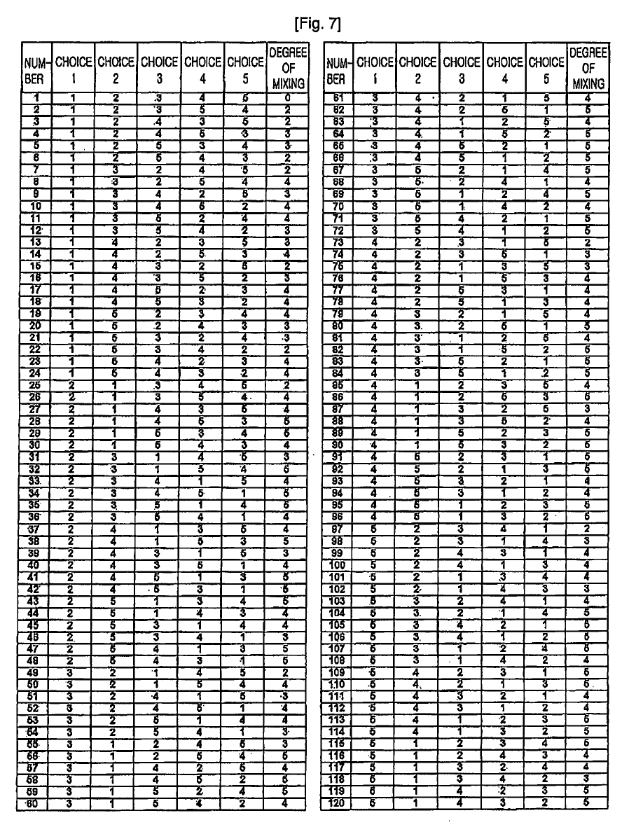

That is, when a question has five choices, and the five choices are mixed, the number of cases becomes 120, as shown in FIG. 7, and the number of cases having the degree of mixing of three or more among them becomes 109.

That is, the number of effective choice mixing for a question becomes 109, and one choice arrangement among them is randomly extracted. In the embodiment of the present invention, the degree of mixing is three or more. In this case, the number of choices in each question is five. Of course, the degree of mixing can be varied according to the number of choices by the questions.

The correct answer arrangement generating section 16 having the above-described configuration can provide different correct answer arrangements by the testees only using the operations of the test sheet information reading section 16a to the correct answer arrangement deciding section 16d. However, because one correct answer in the correct answer arrangement of each testee may be more than other correct answers, the operation of the first correct answer arrangement adjusting section 16e is subsequently required. Further, the degree of correlation of the correct answer arrangement corresponding to a testee to the correct answer arrangements corresponding to adjacent testees (that is, the testees in all directions), that is, similarity to the correct answer arrangements corresponding to adjacent testees, may be high. Accordingly, the operation of the second correct answer arrangement 16f is subsequently required.

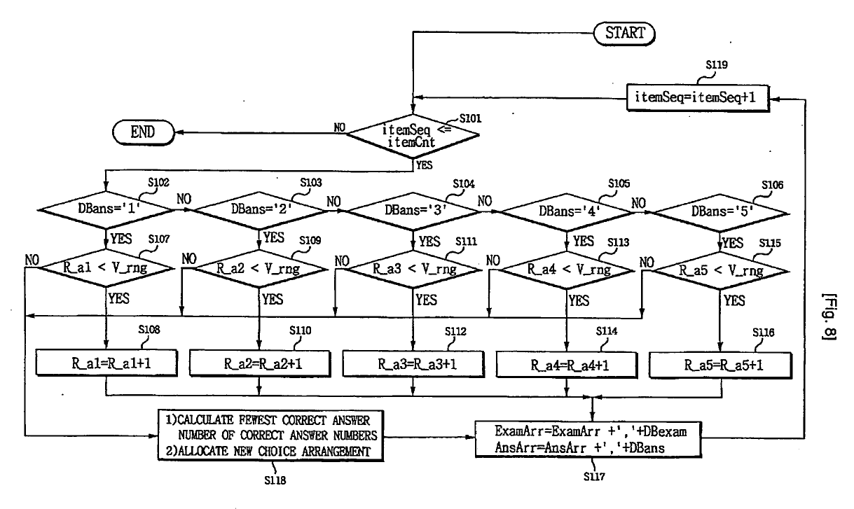

The operation of the first correct answer arrangement adjusting section 16e will be described in detail with reference to a flow chart of FIG. 8.

First, in the following description, the number of questions is represented by “itemCnt”, the maximum/minimum of a same correct answer ratio is represented by “V_ran”, the choice arrangement of each test question number itemSeq is represented by “DBexam”, and the correct answer corresponding to each test question number itemSeq is represented by “DBans”. Further, the accumulated choice arrangements are represented by “ExamArr”, the accumulated correct answer arrangements are represented by “AnsArr”, and the accumulated correct answer ratios by choice numbers a1 to a5 are represented by “R_a1” to “R_a5”, respectively. Here, the description will be given on an assumption that the number of questions itemCnt is 20, all the questions are objective types, and the number of choices for each test question is five.

The first correct answer arrangement adjusting section 16e compares the test question number itemSeq (the initial value is one) with the number of questions itemCnt (Step S101).

As the comparison result, it is judged that the test question number itemSeq is smaller than the number of questions itemCnt, the first correct answer arrangement adjusting section 16e judges which of the choices 1, 2, 3, 4, and 5 of the test question number itemSeq corresponds to the correct answer DBans of the test question number itemSeq is (Steps S102 to S106).

As the judgment result, if the correct answer DBans of the test question number corresponds to the choice number 1 (“Yes” at Step S102), the first correct answer arrangement adjusting section 16e compares the accumulated correct answer ratio R_a1 of the corresponding choice number with the maximum/minimum of the same correct answer ratio V_ran at Step S107, If the maximum/minimum of the same correct answer ratio V_ran is larger than the accumulated correct answer ratio R_a1 of the corresponding choice number, the first correct answer arrangement adjusting section 16e increments the accumulated correct answer ratio R_a1 of the corresponding choice number by “one” (Step S108).

If the correct answer DBans of the test question number corresponds to the choice number 2 (“Yes” at Step S103), the first correct answer arrangement adjusting section 16e compares the accumulated correct answer ratio R_a2 of the corresponding choice number with the maximum/minimum of the same correct answer ratio V_ran at Step S109. If the maximum/minimum of the same correct answer ratio V_ran is larger than the accumulated correct answer ratio R_a2 of the corresponding choice number, the first correct answer arrangement adjusting section 16e increments the accumulated correct answer ratio R_a2 of the corresponding choice number by “one” (Step S110).

If the correct answer DBans of the test question number corresponds to the choice number 3 (“Yes” at Step S104), the first correct answer arrangement adjusting section 16e compares the accumulated correct answer ratio R_a3 of the corresponding choice number with the maximum/minimum of the same correct answer ratio V_ran at Step S111. If the maximum/minimum of the same correct answer ratio Vran is larger than the accumulated correct answer ratio R_a3 of the corresponding choice number, the furst correct answer arrangement adjusting section 16e increments the accumulated correct answer ratio R_a3 of the corresponding choice number by “one” (Step S112).

If the correct answer DBans of the test question number corresponds to the choice number 4 (“Yes” at Step S105), the first correct answer arrangement adjusting section 16e compares the accumulated correct answer ratio R_a4 of the corresponding choice number with the maximum/minimum of the same correct answer ratio V_ran at Step S113, If the maximum/minimum of the same correct answer ratio V_ran is larger than the accumulated correct answer ratio R_a4 of the corresponding choice number, the first correct answer arrangement adjusting section 16e increments the accumulated correct answer ratio R_a4 of the corresponding choice number by “one” (Step S114).

If the correct answer DBans of the test question number corresponds to the choice number 5 (“Yes” at Step S106), the first correct answer arrangement adjusting section 16e compares the accumulated correct answer ratio R_a5 of the corresponding choice number with the maximum/minimum of the same correct answer ratio V_ran at Step S115. If the maximum/minimum of the same correct answer ratio Vran is larger than the accumulated correct answer ratio R_a5 of the corresponding choice number, the first correct answer arrangement adjusting section 16e increments the accumulated correct answer ratio R_a5 of the corresponding choice number by “one” (Step S116).

In such a manner, if the accumulated correct answer ratio (one of R_a1 to R_a5) of the test question number itemSeq is calculated, the first correct answer arrangement adjusting section 16e accumulates the choice arrangement and the correct answer arrangement (Step S117). That is, the relationship ExamArr (Accumulated Choice Arrangements)=ExamArr+‘,’+DBexam (Choice Arrangement of Corresponding Test Question) and the relationship AnsArr (Accumulated Correct Answer Arrangement)=AnsArr+‘,’+DBans (Correct Answer of Corresponding Test Question) are established.

However, it is judged at Steps S107, S109, S111, S113, and S115 that the maximum/minimum of the same correct answer ratio is larger than the accumulated correct answer ratio of the corresponding choice number, that is, “No”, the first correct answer arrangement adjusting section 16c calculates the fewest correct answer number of the used correct answer numbers on the basis of the accumulated correct answer ratios by the choice numbers R_a1 to R_a5 at Step S118, and then allocates a new choice arrangement. Next, the first correct answer arrangement adjusting section 16e performs the operation of Step S117.

Subsequently, the first correct answer arrangement adjusting section 16e performs the expression itemSeq=itemSeq+1 at Step S119, and repeats the operations of Steps S101 to S118. That is, the first correct answer arrangement adjusting section 16e continues to perform the process until the test question number itemSeq is equal to the number of questions itemCnt (for example, 20).

For example, when the original answers of the questions in a test sheet which presents 10 objective questions each having five choices are 4, 5, 2, 2, 3, 5, 5, 4, 2, and 5 in sequence, with the choice arrangement-by-question extracting section 16b and the option processing section 16c, the choice-mixed arrangements DBexam are 32541, 14523, 31425, 31524, 25413, 53142, 12453, 32514, 24135, and 51324. Then, when an actual OMR correct answer arrangement obtained from an arrangement reference after choice mixing (that is, the correct answer arrangement DBans decided by the correct answer arrangement deciding section 16d) is 4, 3, 4, 4, 5, 1, 4, 5, 1, and 1 in sequence, the number of questions having the correct answer number 4 are four, but the number of questions having the correct answer number 2 is zero. That is, the correct answers are poorly distributed.

It is assumed that the adjustment is performed at an poor distribution ratio ranging from 10% to 30%. Then, after the loop is repeated until the condition itemSeq=4 is satisfied, on the basis of the above-described actual OMR correct answer arrangement, R_a1, R_a2, R_a3, R_a4, and R_a5 become 0 (0%), 0 (0%), 1 (10%), 3 (30%), and 0 (0%), respectively. When the condition itemSeq=7 is satisfied, R_a1, R_a2, R_a3, R_a4, and R_a5 become 1 (10%), 0 (0%), 1 (10%), 4 (40%), and 1 (10%), respectively.

Here, because the condition R_a4 (40%)<V_ran (30%) is not satisfied, as regards the fewest correct answer number of the used correct answer numbers, the relationship R_a2=0 (0%) is obtained, and the original correct answer number 5 of the seventh question is located at the position of the second choice in the new choice arrangement (one of the factorial 4, that is, 24 cases is randomly extracted). In the new choice arrangement, for example, if the expression Find_Exam_Arr(5,2)→15423 is established, the choice arrangement 12453 of the seventh number is replaced with 15423, the correct answer number 4 of the seventh question in the OMR is replaced with 2, and the relationship R_a2=1 (10%) and R_a4=3 (30%) are obtained. Next, the loop is repeated under the condition itemSeq=8.

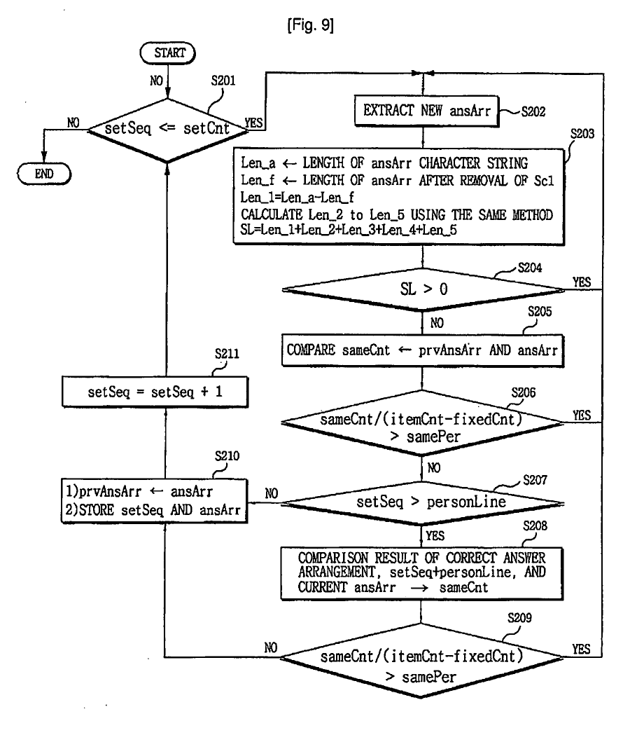

The operation of the second correct answer arrangement adjusting section 16f will be described in detail with reference to a flow chart of FIG. 9.

First, in the following description, a test sheet serial number is represented by “setSeq” (initial value=1), the number of correct answer arrangement issuance of the test sheet is represented by “setCnt”, the number of the same correct answers in the current correct answer arrangement is represented by “sameCnt”, and a ratio of wrong answers by the questions of the test sheet is represented by “diffper”. A ratio of the same answer by the questions of the test sheet is represented by “samePer=(100−diffPer)/100”, and the number of questions corresponding to the option of choice mixing impossible is represented by “fixedCnt”. The number of testees per line is represented by “personLine”, the correct answer arrangement of the test sheet serial number setseq is represented by “ansArr”, and the previous correct answer arrangement is represented by “prvAnsArr”. The possible number of the same answer to be successive is represented by “serialCnt”, and character strings of the same answer numbers are represented by “Sc1” to “Sc5”.

For example, when 30 persons take a test in five columns in a classroom (6 persons per column), the number of testees per line personLine is 6. When serialCnt is 3, the character strings “,1,1,1”, “2,2,2”, “,3,3,3”, “,4,4,4”, and “,5,5,5” are allocated to Sc1 to Sc5, respectively.

The second correct answer arrangement adjusting section 16f judges whether or not the number of correct answer arrangement issuance of the test sheet setCnt is larger than or equal to the test sheet serial number setSeq. If it is judged that the number of correct answer arrangement issuance of the test sheet setCnt is larger than or equal to the test sheet serial number setseq (“Yes” at Step S201), the second correct answer arrangement adjusting section 16f extracts a new correct answer arrangement ansArr relative to the corresponding test sheet serial number setseq (Step S202).

Next, when the character string length of the extracted new correct answer arrangement ansArr is Len_a, and the character string length after the character string length Sc1 is removed from the extracted new correct answer arrangement ansArr is Len_f, the second correct answer arrangement adjusting section 16f calculates Len_1 using the expression Len_1=Len_a−Len_f. Similarly, the second correct answer arrangement adjusting section 16f calculates Len_2, Len_3, Len_4, and Len_5. Then, the second correct answer arrangement adjusting section 16f calculates “SL=Len_1+Len_2+Len_3+Len_4+Len_5” (Step S203).

If the calculated SL is larger than zero (“Yes” at Step S204), the second correct answer arrangement adjusting section 16f returns the process to Step S202, and performs the operation for extracting the new correct answer arrangement ansArr again. Meanwhile, if the calculated SL is smaller than or equal to zero (“No” at Step S204), the second correct answer arrangement adjusting section 16f compares the previous correct answer arrangement prvAnsArr and the correct answer arrangement ansArr of the current test sheet serial number setSeq and assesses the number of the same correct answers sameCnt of the current correct answer arrangement to the previous correct answer arrangement (Step S205).

If the number of the same correct answers sameCnt of the current correct answer arrangement is assessed, the second correct answer arrangement adjusting section 16f judges whether or not “sameCnt/(itemCnt−fixedCnt)” is larger than samePer. When “sameCnt/(itemCnt−fixedCnt)” is larger than samePer (“Yes” at Step S206), the second correct answer arrangement adjusting section 16f returns the process to Step S202 and performs the operation for extracting the new correct answer arrangement ansArr again. Meanwhile, when “sameCnt/(itemCnt−fixedCnt)” is smaller than or equal to samePer (“No” at Step S206), the second correct answer arrangement adjusting section 16f compares the current test sheet serial number setSeq with the number of testees per line personLine.

As the comparison result, when the current test sheet serial number setSeq is larger than the number of testees per line personLine (“Yes” at Step S207), the second correct answer arrangement adjusting section 16f compares a correct answer arrangement obtained by adding the current test sheet serial number setSeq and the number of testees per line personLine with the correct answer arrangement ansArr of the current test sheet serial number so as to assess the number of the same correct answers sameCnt of the current correct answer arrangement (Step S208).

Subsequently, the second correct answer arrangement adjusting section 16f judges whether or not “sameCnt/(itemCnt−fixedCnt)” is larger than samePer. When “sameCnt/(itemCnt−fixedCnt)” is larger than samePer (“Yes” at Step S209), the second correct answer arrangement adjusting section 16f returns the process to Step S202 and performs the operation for extracting the new correct answer arrangement ansArr again. Meanwhile, when “sameCnt/(itemCnt−fixedCnt)” is smaller than or equal to samePer (“No” at Step S209), the second correct answer arrangement adjusting section16f sets the correct answer arrangement ansArr of the current test sheet serial number as prvAnsArr and stores the current test sheet serial number setSeq and the correct answer arrangement ansArr of the current test sheet serial number in the database 14 (Step S210). Even when “No” is judged at Step S207, the second correct answer arrangement adjusting section 16f performs the operation of Step S207.

The operation of the second correct answer arrangement adjusting section 16f will be described again. It is assumed that a test sheet including ten questions each having five choices is used, and the number of testees is 100. Further, it is assumed that the possible number of the same correct answer to be successive serialCnt is defined to be 3, and the number of testees per line is 10. Under the conditions, for example, 100 correct answer arrangements which are different from one another by about 60% or more are obtained for adjacent testees in all directions. Further, it is assumed that setSeq=2, the previous correct answer arrangement prvArr obtained when setSeq=1 is “,4,3,4,2,4,1,2,5,1,1”, and the current correct answer arrangement ansArr obtained when setSeq=2 is “,1,3,4,4,4,3,5,5,2,1”. If the possible number of the same answers to be successive serialCnt is 2, because the correct answers of the third, fourth, and fifth questions are ,4,4,4 when setSeq=2, an inconsistence judgment is held. Accordingly, the process returns to the new ansArr extraction operation (Len_a=20, Len_f=14, Len_4=20−14=6, SL=0+0+0+6+0=6>0).

However, in the example, because the possible number of the same answers to be successive is 3, the process progresses to a same answer ratio operation. Then, because the second, third, fifth, eighth, and tenth questions of prvArr and ansArr have the same answer, an effective result of 50% may occur during cheating.

Therefore, because a difference has to be 60% or more, an inconsistence judgment is held, and the process returns to the new ansArr extraction operation again. If the difference is 60% or more, a difference between adjacent testees for ten persons per line needs to be checked.

Since when the test sheet serial number setSeq>personLine (10), a difference between the correct answer arrangement of the test sheet having a value of setSeq−personline and the correct answer arrangement of current setSeq is checked using the same method. In this case, if the difference is less than 60%, an inconsistence judgment is held, and then the process returns to the new ansArr extraction operation again. Meanwhile, if the difference is more than 60%, setSeq and decided ansArr are stored in the database, and then the process is repeated for the next test sheet number.

The second converting section 18 includes a DOC converting section 18a which converts the multiple data files into documents for a word processor, and an HTML (HyperText Markup Language) converting section 18b which converts the multiple data files into HATL documents.

The documents for a word processor output from the DOC converting section 18a are transmitted to a print-ondemand (POD) system 22, and the HTML documents output from the HTML converting section 18b are displayed on the screen of a terminal of the testee through a web browser.

The DOC converting section 18a and the HThIL converting section 18b may selectively operate according to situations or may simultaneously operate. That is, when the test questions are provided to the print-on-demand system 22 on an offline for test sheet printing, the test questions are finally transmitted to the print-on-demand system 22 through the DOC converting section 18a. Further, when a member on an online requests the test questions, the test questions are finally transmitted to the member through the HTML converting section 18b.

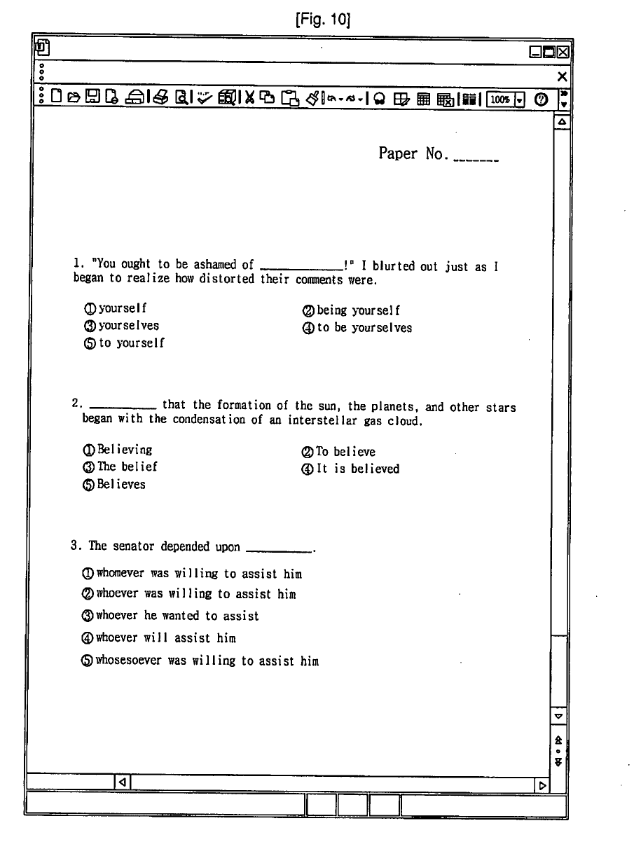

The DOC converting section 18a first searches question information (for example, a unique ID, a sequence, scores, and so on) for constructing an original test sheet file from the database 14, reads out the passages by the questions and the questions according to the searched question information, and then constructs the original test sheet file (which is also referred to a master test sheet file) with the passages and the questions (see FIG. 10).

Here, the questions are inserted using a basic test sheet template, and the question numbers and mark information by the questions are added to the test sheet.

Next, the DOC converting section 18a performs an edition such as the insertion of a notice into the completed original test sheet file (master test sheet file) so as to increase a degree of completion.

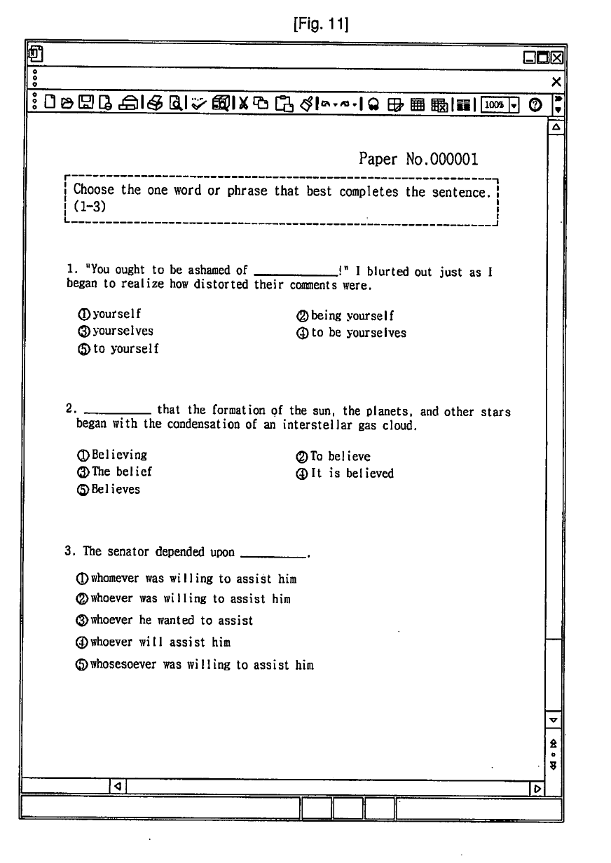

Here, a general-use word processor program (for example, “WORD” of Microsoft Corporation) is used for the edition. In this case, an adjustment of a space between the questions, a specific font processing, and so on are performed. Further, additional corrections (for example, a test notice, a notice for hearing, a notice for a group of questions, and so on) are inserted into the test sheet. The edited master test sheet file may be as shown in FIG. 11.

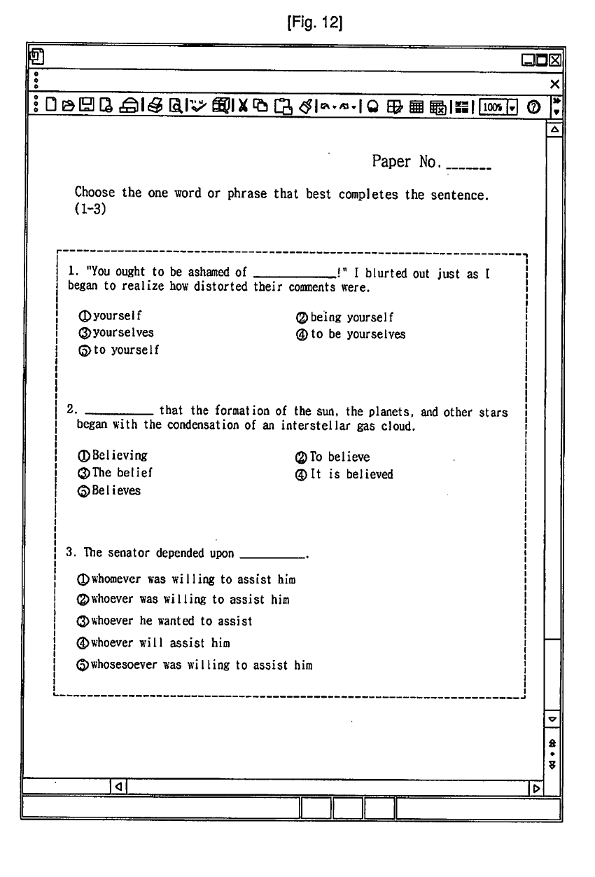

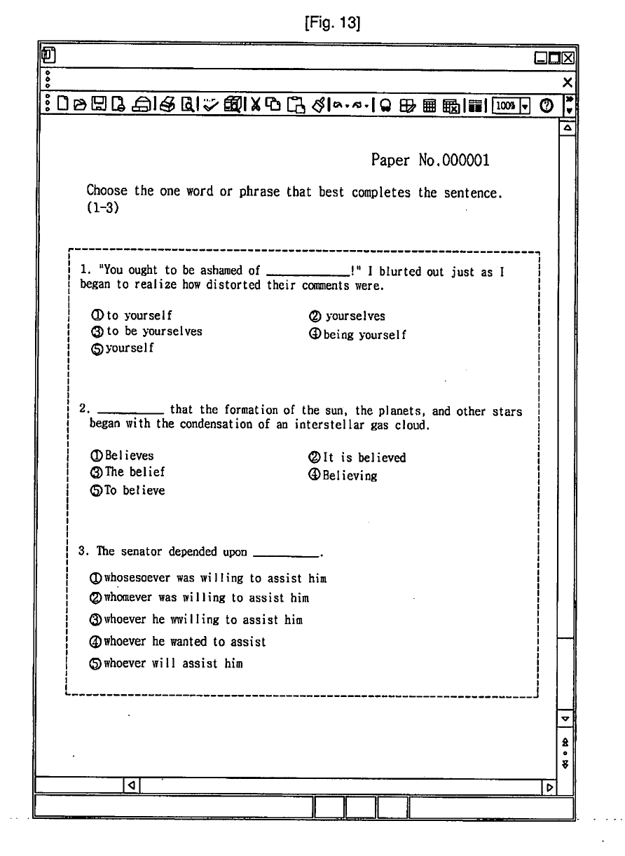

Subsequently, the DOC converting section 18a searches choice mixing information by test sheets. Specifically, the DOC converting section 18a searches sets of the choice arrangement and the correct answer arrangement corresponding to the testees by the test sheets previously generated from the database 14, converts the edited master test sheet file so as to generate test sheet files (see FIGS. 12 and 13) by the testees (for example, the document files for a word processor). At this time, the unique test sheet IDs are individually inserted into the test sheet files, and the original choice arrangements by the questions are converted into the new choice arrangements.

Referring to FIGS. 12 and 13, the questions are presented in the same sequence, but the choice arrangements dependent on the individual questions are different from each other. Alternatively, the sequence of the questions and the choice arrangements of the individual questions can be different from each other.

Meanwhile, the HTML converting section 18b also performs the same detailed operations as the DOC converting section 18a. The operations since when the test sheet files are generated by the number of testees are the same. The test sheet generated by the HTML converting section 18b is output onto the online. Therefore, the test sheet may be a single test sheet or multiple test sheets.

In particular, because the test sheet files generated by the HTML converting section 18b are XML codes or XML files, the conversion of the generated test sheet files into the HTML documents are additionally performed.

The conversion of the XML documents for a word processor to be performed by the HTML converting section 18b can be seen through the web browser during a process of data files (XML)→XSL conversion→HTML documents.

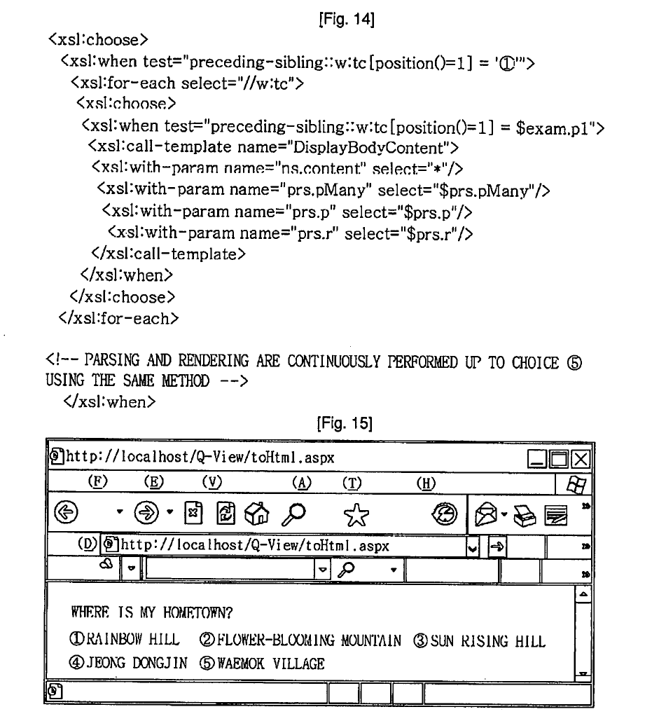

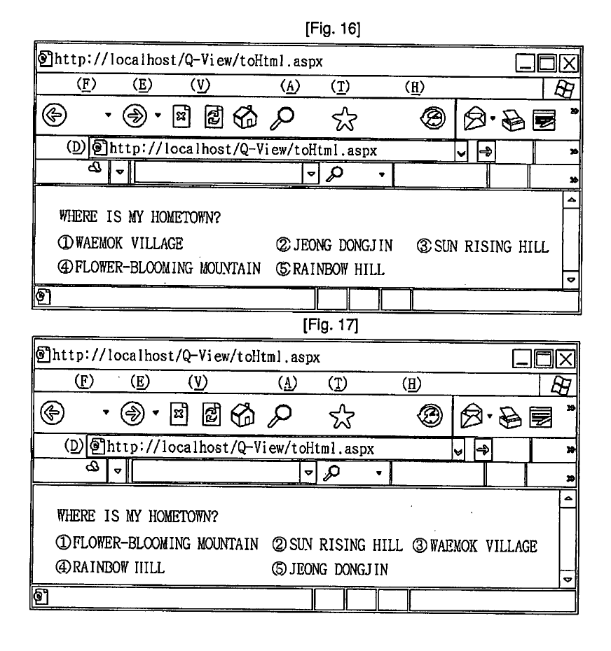

For example, the content of XSL (eXtensible Style Language) for converting XML to HTML (that is, xml_to_html.xsl) is as shown in FIG. 14. The results after choice mixing can be seen through the web browser. First, FIG. 15 shows the original state before choice mixing. FIG. 16 shows a choice arrangement in a sequence of 5, 4, 3, 2, and 1 on the basis of the original state. Further, FIG. 17 shows a choice arrangement in a sequence of 2, 3, 5, 1, and 4 on the basis of the original state. As shown in FIGS. 15 to 17, the same question is presented to the individual testees in a state where the choice arrangement is changed, and thus cheating among the testees is prevented.

In FIG. 1, one print-on-demand system 22 is shown, but a plurality of print-on-demand systems may be provided, if necessary.

The control section 20 controls the storage operation to the database 14 depending on whether or not the questions and the meta information thereof are received from the examiner. Further, the control section 20 operates the correct answer arrangement generating section 16 and the second converting section 18 when a member requests a test sheet through a communication network such as Internet or an orderer on the offline requests a test sheet.

The control section 20 stores information for member authentication in advance. Of course, the information for member authentication may be stored in the second storage section 14b. Further, the control section 20 provides basic information (for example, the test subject, the number of testees, the number of questions, and so on) such that the correct answer arrangement generating section 16 may generate correct answer arrangement information. In addition, the control section 20 receives the correct answer arrangement information from the correct answer arrangement generating section 16 and temporarily stores that information in order to monitor whether or not the conversion operation in the second converting section 18 is normally performed according to the correct answer arrangement information generated by the correct answer arrangement generating section 16.

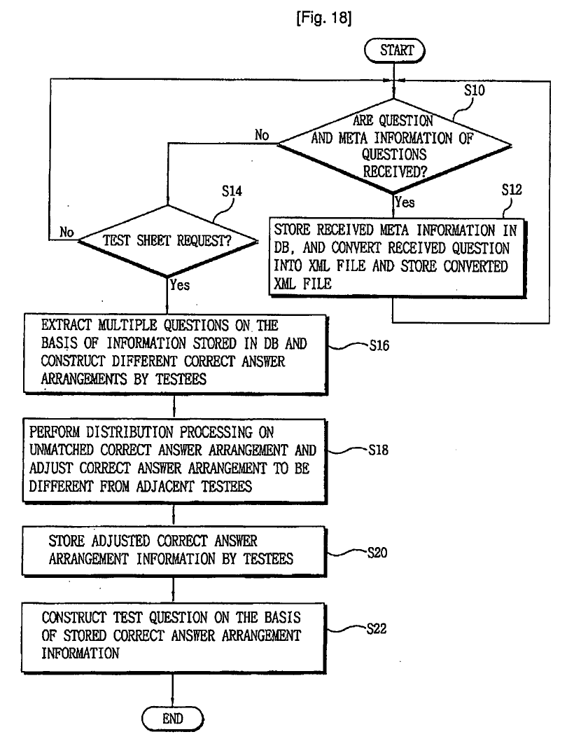

Next, a test question constructing method according to an embodiment of the present invention will be described in detail with reference to a flow chart of FIG. 18.

First, the control section 20 judges whether or not the questions and the meta information including the attributes of the questions to be received from the receiving section 10 exist. As the judgment result, if the questions (questions created by a word processor) and the meta information dependent on the questions exist (“Yes” at Step S10), the control section 20 stores the meta information dependent on the corresponding question received through the receiving section 10 in the second storage section 14b of the database 14 and instructs the XML converting section 12 to perform the XML conversion.

Accordingly, the XML converting section 12 receives the questions to be provided from the receiving section 10 and stores the contents and the typesetting information of the corresponding question in the first storage section 14a of the database 14 (Step S12). If the questions and the meta information dependent on the corresponding question are input, the storage operation to the database 14 is performed under the control of the control section 20.

If test sheet request information is input online or offline in a state where the questions and meta information are not further input (“Yes” at Step S14), the control section 20 instructs the correct answer arrangement generating section 16 to generate the correct answer arrangement and provides the basic information (the test subject, the number of testees, the number of questions, the number of testees per line) required for correct answer arrangement generation.

Accordingly, the correct answer arrangement generating section 16 constructs the number of questions and the choices of a certain test subject using the data files and the meta information of the database 14, and also constructs the constructed correct answer arrangement of the questions to be varied by the testees (Step S16). A basic operation for constructing different correct answer arrangements by the testees is performed by the test sheet information reading section 16a, the choice arrangement-by-question extracting section 16b, the option processing section 16c, and the correct answer arrangement deciding section 16d of the correct answer arrangement generating section 16. The constructed correct answer arrangements by the testees are stored in the database 14.

Then, the correct answer arrangement generating section 16 assesses whether or not the correct answers in the generated correct answer arrangements by the testees are poorly distributed, on the basis of different correct answer arrangements generated by the testees and performs the distribution processing. Further, the correct answer arrangement generating section 16 performs the processing such that the correct answer arrangement of a testee is made different from the correct answer arrangements of adjacent testees (testees in all directions) (Step S18).

Next, the correct answer arrangement generating section 16 stores the adjusted correct answer arrangement information by the testees (that is, information when the distribution processing of the poorly distributed correct answers and the processing of making the correct answer arrangement to be different from those of adjacent testees are completed) in the second storage section 14b (Step S20), and transmits the correct answer arrangements by the testees to the control section 20 while notifying the control section 20 that the correct answer arrangement information is stored.

Subsequently, the control section 20 controls the second converting section 18 to perform the conversion operation.

That is, the DOC converting section 18a reads out the data file from the database 14 and converts it into the document for a word processor under the control of the control section 20. Further, the DOC converting section 18a separately mixes the choices of each question on the basis of the meta information of the corresponding data file such that the testees receive the test sheets having different correct answer arrangements.

In such a manner, the DOC converting section 18a constructs the test sheets according to the number of testees (Step S22), and thus the testees receive the same test questions but have the test questions having different correct answer arrangements. The test questions output from the DOC converting section 18a are transmitted to the print-on-demand system 22 on the offline and are printed on the test sheets. Then, the test sheets are distributed to the testees.

Meanwhile, the HTML converting section 18b reads out the data file from the database 14, converts the data file into the HTML document, and mixes the choices of each question on the basis of the meta information of the corresponding data file such that the testees receive the test sheets having different correct answer arrangements.

In such a manner, the HTML converting section 18b constructs the test sheets according to the number of testees (Step S22), and thus the testees receive the same test questions having different correct answer arrangements on the online. The test questions output from the HTML converting section 18b are displayed onto the screens of the terminals of the testees online.

The DOC converting section 18a and the HTML converting section 18b do not simultaneously operate constantly. When the test questions are provided to the print-on-demand system 22 on the offline for test sheet printing, the test questions are transmitted to the print-on-demand system 22 through only the DOC converting section 18a. Further, when a member on the online requests the test questions, the test questions are transmitted to the member through only the HTML converting section 18b.

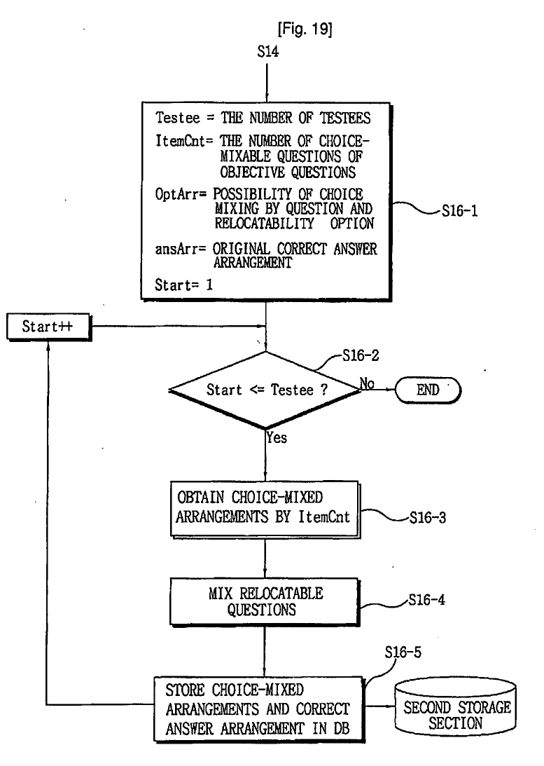

The correct answer arrangement generation and storage process in the above description will be described in detail with reference to a flow chart of FIG. 19.

In order to generate a variable correct answer arrangement according to the number of testees, the correct answer arrangement generating section 16 starts the correct answer arrangement generation operation in a state where the number of testees Testee, the number of choice-mixable questions ItemCnt among the objective questions, the possibility of choice mixing by the questions and relocatability option OptAn., the original correct answer arrangement ansArr, and so on are set in advance.

At the beginning, the correct answer arrangement generating section 16 compares the number of testees Testee (for example, 10) and a comparison value Start (1). The comparison operation can be performed by the control section 20. At the beginning, because the comparison value Start is smaller than the number of testees (“Yes” at Step S16-2), the correct answer arrangement generating section 16 obtains the choice-mixed arrangements according to the number of choice-mixable questions ItemCnt among the objective questions from the selected test questions (that is, the data file) (Step S16-3).

Next, the correct answer generating section 16 mixes the relocatable questions according to the possibility of choice mixing by the questions and the relocatability option OptArr (Step S16-4).

If the choice-mixed arrangements and the correct answer arrangement for the test questions of the first testee are obtained in such a manner, the information is temporarily stored in the second storage section 14b (Step S16-5). Next, the previous comparison value is incremented by one, and the process progresses to Step S16-2. Subsequently, the operations from Step S16-2 are repeated. Such an operation stops if the number of testees Testee is larger than or equal to the comparison value Start.

If the choice-mixed arrangements (choice-mixed states in FIG. 4 or 5) and the correct answer arrangements (OMR correct answer arrangements of FIG. 4 or 5) of the test questions for all testees are generated in such a manner, the correct answer arrangement generating section 16 performs the operation of Step S18 in FIG. 18.

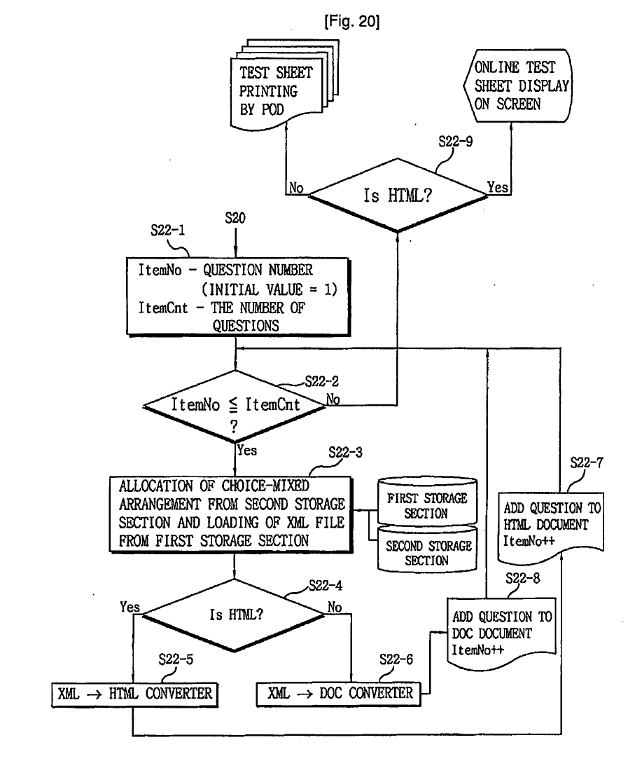

The operation for constructing the test questions according to the correct answer arrangement in the description of FIG. 18 will be described in detail with reference to a flow chart of FIG. 20. ItemNo represents a question number (initial value=1), and ItemCnt represents the number of questions according to the correct answer arrangement (Step S22-1).

At the beginning, the second converting section 18 compares the question number ItemNo with the number of questions ItemCnt (for example, 10). The comparison operation can be performed by the control section 20. At the beginning, because the question number ItemNo is smaller than the number of questions ItemCnt (“Yes” at Step S22-2), the choice-mixed arrangement is allocated to the second converting section 18 from the second storage section 14b, and the data file corresponding to the first question number is loaded from the first storage section 14a (Step S22-3).

Subsequently, when the loaded data file is to be converted into the HTML document (“Yes” at Step S22-4), the HTML converting section 18b of the second converting section 18 operates (Step S22-5), and then the conversion result in the HTML converting section 18b is added to the HTML document as a question (Step S22-7). Meanwhile, when the loaded data file is to be converted into the document for a word processor (“No” at Step S22-4), the DOC converting section 18a of the second converting section 18 operates, and then the conversion result in the DOC converting section 18a is added to the document for a word processor as a question (Step S22-8). Here, an instruction about whether loaded data is to be converted into the HTML document or the document for a word processor is made by the control section 20.

In such a manner, if one question is added, the previous question number ItemNo is incremented by one. Next, the operation of Step S22-2 is performed, and then the above-described operation is continued.

During the operation, if the question number ItemNo becomes larger than the number of questions ItemCnt, a further document conversion operation is not performed, and the test questions constructed by the conversion operations until then are output.

That is, when outputting onto the online (“Yes” at Step S22-9), the constructed test questions are displayed on the screen of the terminal of each testee through the online in a test sheet shape. Meanwhile, when outputting onto the offline (“No” at Step S22-9), the constructed test questions are transmitted to the print-on-demand system 22, and then are printed by the print-on-demand system 22 in a test sheet shape.

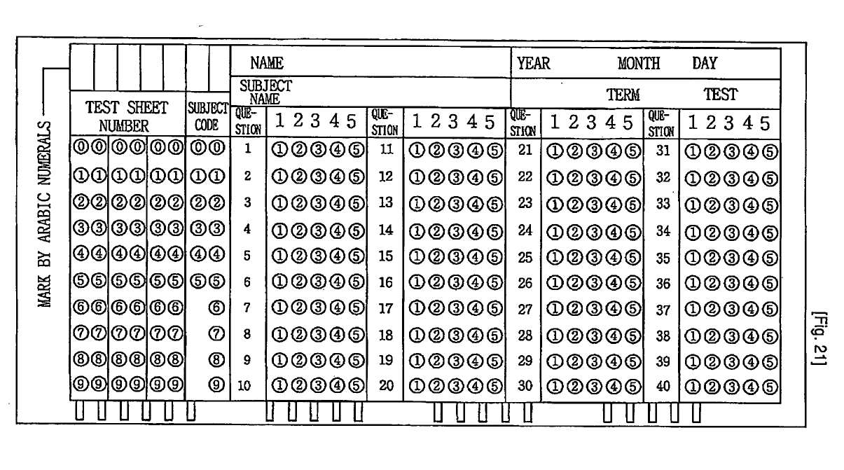

A member who takes a test on the online or a testee who takes a test on the offline records the answers into an OMR card shown in FIG. 21. Of course, the member who takes the test on the online can input the answers using an input unit of his/her terminal. In FIG. 21, different test sheet numbers of 0 to 999,999 are issued for 1,000,000 persons.

In the above-described embodiment of the present invention, a document for a word processor has been illustrated as one type of easily writable, editable, and printable documents, and an HTML document which is a standard and general-use document has been illustrated as one type of documents to be easily viewed online. Of course, other types of documents can be provided through appropriate conversion.

It should be understood that the present invention is not limited to the above-described embodiment, various modifications and changes may be made without departing from the subject matter or spirit of the present invention. Therefore, technical features that accompany such modifications and changes still fall within the scope of the present invention read on the appended claims.

1. A test question constructing apparatus, comprising:
a receiving unit which receives multiple questions and meta information having attributes of the individual questions through a network;
a first converting unit which converts the individual questions input through the receiving unit into data files having contents and typesetting information;
a database which stores the multiple data files and meta information of the individual questions passing through the receiving unit;
a correct answer arrangement generating unit which includes:
a test sheet information reading section which reads multiple test sheet information for constructing a test sheet from the database,
a choice-by-question arrangement extracting section which mixes choices of each question on the basis of the read multiple test sheet information and extracts choice arrangements having a degree of mixing more than a prescribed degree of mixing,
a correct answer arrangement deciding section which randomly selects one choice arrangement among the extracted choice arrangements for each test question by testees, and decides a correct answer from the selected choice arrangement as a correct answer of the corresponding test question, and
a first correct answer arrangement adjusting section which checks whether or not correct answers in a correct answer arrangement decided for each testee are poorly distributed and, when the correct answers are poorly distributed, performs a distribution processing; and
a second converting unit which generates and outputs test question files having different correct answer arrangements by the testees on the basis of final correct answer arrangement information from the correct answer arrangement generating unit.

2. The test question constructing apparatus of claim 1,
wherein the correct answer arrangement generating unit includes a second correct answer arrangement adjusting section which, after the distribution processing is performed depending on whether or not the correct answers in the generated correct answer arrangement are poorly distributed, compares the correct answer arrangement of each testee with the correct answer arrangements of adjacent testees so as to adjust a degree of correlation.

3. The test question constructing apparatus of claim 1,
wherein the test question files output from the second converting unit are documents for a word processor or documents having formats to be viewable online.

4. A test question constructing method, comprising:
a first process of causing a receiving unit to receive multiple questions and meta information having attributes of the individual questions through a network;
a second process of causing a first converting unit to convert the individual questions input through the receiving unit into data files having contents and typesetting information and causing a database to store the data files;
a third process of causing a correct answer arrangement generating unit to read multiple test sheet information from the database so as to construct questions and choices by questions of a test subject, to adjust a choice arrangement of each question by testees according to a prescribed degree of mixing so as to generate different correct answer arrangements by the testees, and to perform a distribution processing depending on whether or not the correct answers in each of the generated correct answer arrangements by the testees are poorly distributed; and
a fourth process of causing a second converting unit to generate and output test question files having different correct answer arrangements by the testees on the basis of final correct answer arrangement information obtained in the third process.

5. The test question constructing method of claim 4,
wherein the third process further includes causing the correct answer arrangement generating unit to compare a correct answer arrangement of each testee with correct answer arrangements of adjacent testees and to adjust a degree of correlation after the correct answer arrangement generating unit performs the distribution processing.

6. The test question constructing method of claim 4,
wherein the test question files in the fourth process are documents for a word processor or documents having formats to be viewable online.

7. A test sheet fabricated by the test question constructing method of claim 4.

8. A test sheet fabricated by the test question constructing method of claim 5.

9. A computer-readable medium storing a test question constructing program for executing the test question constructing method of claim 4.

10. A computer-readable medium storing a test question constructing program for executing the test question constructing method of claim 5.
